(19) United States
(12) Patent Application Publication
(10) Pub. No.: US 2024/0182101 A1
(43) Pub. Date: Jun. 6, 2024

(54) Operating Unit for Arrangement on a Steering Wheel in a Motor Vehicle

(71) Applicant: Bayerische Motoren Werke Aktiengesellschaft, Muenchen (DE)

(72) Inventors: Stefan BAST, Muenchen (DE); Benjamin BRUECK, IRSCHENBERG (DE); Hermann DELL, Muenchen (DE); Thomas HILGER, Iffeldorf (DE); Christian KNOLL, Muenchen (DE); Stephan MUELLER, Muenchen (DE); Martin SCHIMID, Muenchen (DE); Hannes TRAPP, Muenchen (DE)

(21) Appl. No.: 18/499,344

(22) Filed: Nov. 1, 2023

(30) Foreign Application Priority Data
Dec. 1, 2022 (DE) 10 2022 131 856.7

(51) Int. Cl. B62D 1/04

(52) U.S. Cl. CPC B62D 1/046

(57) ABSTRACT

An operating unit for arrangement on a steering wheel in a motor vehicle includes a plurality of operating elements of a first functional group and a plurality of operating elements of a second functional group. The operating unit also has a relief-like main body having a central plateau, an upper bevel and a lower bevel, wherein the operating elements of the first functional group are arranged in the central plateau and the operating elements of the second functional group are arranged in the upper bevel and the lower bevel.

### CROSS REFERENCE TO RELATED APPLICATION

This application claims priority under 35 U.S.C. § 119 from European Patent Application No. 102022131856.7, filed Dec. 1, 2022, the entire disclosure of which is herein expressly incorporated by reference.

### BACKGROUND AND SUMMARY

The present disclosure relates to an operating unit for arrangement on a steering wheel in a motor vehicle, to a steering wheel having an operating unit, and to a motor vehicle having an operating unit. The disclosure therefore lies in the field of operating elements for motor vehicles.

Motor vehicles typically have one or more operating units which are arranged on the steering wheel and can be operated using the fingers, while the hands hold the steering wheel. This makes it possible to actuate functions by means of the operating units without having to remove the hands from the steering wheel. However, in order to operate some operating units, it may be necessary for a driver to direct his gaze to the operating unit for a monitoring glance in order to ensure that the desired function is performed with the intended actuation of the operating unit. This may be the case, in particular, when the driver is not familiar or is only slightly familiar with the operating concept of the vehicle or because the operating unit does not make it possible to adequately distinguish between the individual operating elements and the associated functions.

Against the background of this prior art, the object of the present disclosure is to provide an improved operating unit which is suitable for enhancing the prior art. A specific configuration of the disclosure can achieve the object of facilitating the operation of an operating unit arranged on the steering wheel of a motor vehicle.

The object is achieved by means of the features of the respective independent claims. The dependent claims relate to optional developments of the invention.

Accordingly, the object is achieved by means of an operating unit for arrangement on a steering wheel in a motor vehicle. The operating unit comprises a plurality of operating elements of a first functional group and a plurality of operating elements of a second functional group. The operating unit is distinguished by the fact that the operating unit also comprises a relief-like main body having a central plateau, an upper bevel and a lower bevel, wherein the operating elements of the first functional group are arranged in the central plateau and the second operating elements of the second functional group are arranged in the upper bevel and the lower bevel.

An operating unit may have a plurality of operating elements, for example buttons, levers and/or touch elements, wherein the operating unit is designed to provide the operating elements at a predefined position, such that the driver or user of the motor vehicle can actuate them. The fact that the operating unit is designed to be arranged on a steering wheel means that the operating unit is intended to be arranged on or beside a steering wheel in the motor vehicle, with the result that the driver can actuate the operating elements of the operating unit while his hands are on the steering wheel.

A functional group of operating elements is a subset of all operating elements which are thematically connected to one another in terms of the functions that can be performed with the operating elements. For instance, different functional groups may be aimed at the control of media contents, the control of a telecommunications or telephone function and/or the control of driving functions. Alternatively or additionally, the operating elements of a functional group may be associated with one another to the effect that their respective frequency of actuation is in a similar range. For example, operating elements which are actuated particularly frequently may be combined in one functional group.

A relief-like main body is a main body having a three-dimensional shape which makes it easier for the user or driver to feel certain regions or elements. For this purpose, the main body may have, in particular, elevations, depressions, chamfers, curves, edges, joints, corners, roughened areas and/or similar formations and/or surface finishes which can be felt by the driver or user.

The central plateau is a region of the relief-like main body which, in a central region of the operating unit, constitutes a platform which optionally faces the driver and on which operating elements formed there are particularly exposed and easily accessible to the driver. The upper bevel is optionally a chamfer on the upper end of the central plateau. The lower bevel is optionally a chamfer on the lower end of the central plateau.

The disclosure provides the advantage that the operating elements can be clearly divided according to the functional groups to which they are assigned and the clarity can therefore be increased and intuitive operation can be enabled. In other words, this makes it possible to consistently group or cluster operating elements for particular functions, which makes it easier to find the desired functions and assists with setting up a mental model for operating the operating unit. This makes it possible to accelerate the ability to learn the operating concept and therefore to reduce the risk of incorrect operation during the journey. Consequently, the disclosure provides an increase in safety for road traffic.

The disclosure also provides the advantage that it allows small-scale zoning of the operating element and, in this manner, facilitates haptic orientation for the driver. This can be associated with the fact that the structure of the operating unit is also quickly revealed to the eye when looked at. In particular, the central plateau, the upper bevel and the lower bevel may therefore each constitute a zone which can be optionally haptically and optically easily delimited from the other zones.

The upper bevel and the lower bevel may be chamfered with respect to the central plateau. This may make it easier to find the upper and/or lower bevel and the operating elements arranged there. In addition, this can assist with the haptic delimitation from the central plateau, with the result that the delimitation of the zones optionally associated therewith can be improved.

The operating elements of the second functional group may optionally comprise at least some of the following operating elements: operating elements for controlling a playback volume, and operating elements for gradually changing the playback title. These operating elements are thematically closely related since they are aimed at the playback of media contents. In addition, they are in a prioritization relationship with one another since they are typically very frequently used functions and accordingly frequently actuated operating elements. Accordingly, the operating elements of the second functional group may be optionally positioned such that they are easily accessible and can easily be found.

The operating elements of the first functional group may comprise at least some of the following operating elements: operating elements for list navigation and/or menu control, operating elements for selecting the source for the playback of media contents, and operating elements for controlling a telephone function. The operating elements of the first functional group are optionally thematically related to one another since they are typically actuated during a longer-lasting input, in particular in order to look for elements in a list and to select one or more of these elements from the list. This may be, for example, a list of media contents for playback and/or entries from a telephone book for the telephone function. The operating elements of the first functional group optionally have a lower prioritization than the operating elements of the second functional group with regard to the frequency of their use.

The operating elements for the list navigation and/or menu control may comprise a plurality of cursor buttons. In this case, one cursor button of the plurality of cursor buttons may be optionally arranged on the upper edge of the central plateau, one cursor button may be optionally arranged on the lower edge of the central plateau, one cursor button may be optionally arranged on the left-hand edge of the central plateau and one cursor button may be optionally arranged on the right-hand edge of the central plateau. This provides the advantage that, as a result of the arrangement of the cursor buttons, the direction in which a movement in the menu can result in the actuation of the respective cursor button can be easily revealed to the driver. The cursor buttons may be, in particular, press functions, in the case of which a function can be performed by virtue of the driver using a finger to press the buttons.

The plurality of cursor buttons may be raised in a relief-like manner with respect to the central plateau. This provides the advantage of easier haptic findability. In addition, as a result, the cursor buttons may represent a “haptic anchor” in the sense of a haptic reference point. The raised position of the cursor buttons may also express a prioritization and indicate the importance of these cursor buttons. In addition, other adjacent operating elements can be effectively haptically and optionally optically delimited from the cursor buttons by means of the cursor buttons and their arrangement and raised nature by virtue of the other adjacent operating elements optionally not being raised.

The operating unit may optionally also have a touch operating element. The touch operating element may be optionally arranged in a relief-like depression in the central plateau. Optionally, the relief-like depression may be arranged, with the touch operating element, between the cursor buttons. The depression and the touch operating element may optionally be formed in an elongated manner, running in a vertical direction, in the form of a trough and may allow a displacement movement or scrolling movement in the vertical direction by means of a touch movement. The relief-like depression may be used in this case as a haptic anchor in the sense of a haptic reference point that can easily be found. Lists are often presented as a list of elements arranged vertically below one another since this corresponds to the reading habits of many people. The fact that the touch operating element allows a scrolling movement in the vertical direction may therefore enable intuitive control by means of lists and menus. In addition, the arrangement of the touch operating element in the relief-like depression may protect the touch operating element from unintentional actuation during swiping movements. In addition, the depression, in particular a trough shape, may guide the finger during the scrolling movement along the vertical direction and may therefore enable precise operation without the need for a monitoring glance. In addition, the touch operating element may be configured to perform and/or confirm an input by pressing the touch operating element. In this case, the touch operating element may be designed such that it is possible to press at any point of the touch operating element for input. This may provide the advantage that, after having made a selection by means of the scrolling movement, the driver or user does not have to around to a particular point on the touch operating element or even an external button in order to confirm the input. This makes it possible to increase the operating comfort and reduce the risk of false activations and, in particular, unwanted repositioning of the cursor in the menu or in the list. The touch operating element may optionally be provided with a surface structure which promotes a sliding movement of a finger over the touch operating element. This makes it possible to reduce material wear and/or skin irritations on the finger in the event of frequent use. The relief-like depression of the touch operating element and optionally the raised cursor buttons may optionally achieve a visual, haptic and logic separation of press operating elements, that is to say operating elements for which actuation is effected by pressing and swipe operating elements for which actuation is effected by means of a touch input, which can counteract incorrect operation. Navigation through lists and menus may optionally also be possible by means of the cursor buttons. This provides the advantage that swipe actuation of the touch operating element is not absolutely necessary, which may be an advantage for some users.

The cursor buttons may optionally be chamfered or beveled in a manner tapering to the depression. This may provide the advantage that the thumb or finger is optionally centered on the middle during raising and is accurately braked during a fast change from opposite ends. If the touch operating element is formed between the cursor buttons, haptic centering on the touch operating element can therefore also be effected. This makes it possible to facilitate blind operability or operability without a monitoring glance.

The operating unit may also have an operating element of a third functional group, which operating element may be arranged in the central plateau and may be raised in a relief-like manner with respect to the central plateau. The operating element of the third functional group may optionally have an operating element for activating a voice control function or may be in the form of such an operating element. This may be arranged, for example, on the left-hand edge of the central plateau, optionally between the edge of the central plateau and the left-hand cursor button. The operating element for activating a voice control function may optionally be raised or recessed with respect to the central plateau in order to improve its findability.

A steering wheel is also provided and is distinguished by the fact that the steering wheel comprises at least one operating unit explained above. The above disclosure relating to the operating unit can also be considered to be disclosed for a steering wheel, and vice versa.

A motor vehicle is also provided and is distinguished by the fact that the motor vehicle comprises at least one operating unit explained above. The above disclosure relating to the operating unit can also be considered to be disclosed for a motor vehicle, and vice versa.

The motor vehicle may be a passenger vehicle, in particular an automobile, or a commercial vehicle such as a truck. The motor vehicle may be designed to at least partially and/or at least temporarily undertake longitudinal guidance and/or lateral guidance during automated driving of the motor vehicle. Automated driving can be carried out such that the motor vehicle is moved (largely) autonomously. Automated driving may be at least partially and/or temporarily controlled by the data processing apparatus.

It goes without saying that the features and embodiments mentioned above and explained below can be considered to be disclosed not only in the respectively explicitly mentioned combinations but also that other technically meaningful combinations and embodiments are included in the disclosure content.

Optional embodiments are described below with reference to the figures.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows an operating unit according to an optional embodiment for arrangement on a steering wheel in a motor vehicle; and

FIG. 2 shows a schematic illustration of a motor vehicle according to an optional embodiment.

In the figures, the same reference signs are used for identical or similar elements. In the descriptions of the figures, reference signs are sometimes stated even though the respective element can possibly be seen only in other figures.

### DETAILED DESCRIPTION OF THE DRAWINGS

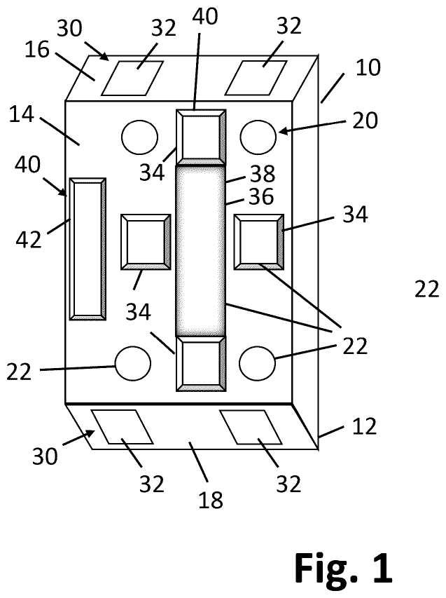

FIG. 1 shows an operating unit 10 according to an optional embodiment for arrangement on a steering wheel 100 in a motor vehicle 200. The operating unit 10 comprises a plurality of operating elements 22 of a first functional group 20 and a plurality of operating elements 32 of a second functional group 30. The operating unit 10 is distinguished by the fact that the operating unit 10 also has a relief-like main body 12 with a central plateau 14, an upper bevel 16 and a lower bevel 18, wherein the operating elements 22 of the first functional group 20 are arranged in the central plateau 14 and the second operating elements 32 of the second functional group 30 are arranged in the upper bevel 16 and the lower bevel 18. The upper bevel 16 and the lower bevel 18 are chamfered with respect to the central plateau 14. In this case, an edge may arise at the transition between the central plateau 14 and the respective bevel 16, 18. According to some optional embodiments, the transition between the central plateau 14 and the respective bevel 16, 18 may be rounded.

The operating elements 32 of the second functional group 30 may have operating elements 32 for controlling a playback volume and/or operating elements 32 for gradually changing the playback title.

The operating elements 22 of the first functional group 20 may comprise operating elements 22 for list navigation and/or menu control, and/or operating elements 22 for selecting the source for the playback of media contents, and/or operating elements 22 for controlling a telephone function. In particular, the operating elements 22 for list navigation and/or menu control may comprise a plurality of cursor buttons 34, wherein one cursor button 34 of the plurality of cursor buttons 34 may be arranged on the upper edge of the central plateau 14, one cursor button 34 may be arranged on the lower edge of the central plateau 14, one cursor button 34 may be arranged on the left-hand edge of the central plateau 14 and one cursor button 34 may be arranged on the right-hand edge of the central plateau 14. A partial selection of these arrangements of the cursor buttons 34 is also possible. According to the optional embodiment illustrated, the plurality of cursor buttons 34 are raised in a relief-like manner with respect to the central plateau 14.

The operating unit 10 also has a touch operating element 36 which is arranged in a relief-like depression 38 in the central plateau 14. The depression 38 is arranged, with the touch operating element 36, between the cursor buttons 34. According to an optional embodiment, the cursor buttons 34 may be chamfered in a manner tapering to the depression 38.

The operating unit 10 may also have an operating element 42 of a third functional group 40, which operating element is arranged in the central plateau 14 and may be raised in a relief-like manner with respect to the central plateau 14. The operating element 42 of the third functional group 40 may optionally have an operating element 42 for activating a voice control function or may be in the form of such an operating element. The operating element 42 of the third functional group 40 may be arranged, for example, on the left-hand edge of the central plateau 14, optionally between the edge of the central plateau 14 and the left-hand cursor button 34. The operating element 42 for activating a voice control function may be optionally raised or recessed with respect to the central plateau in order to improve its findability.

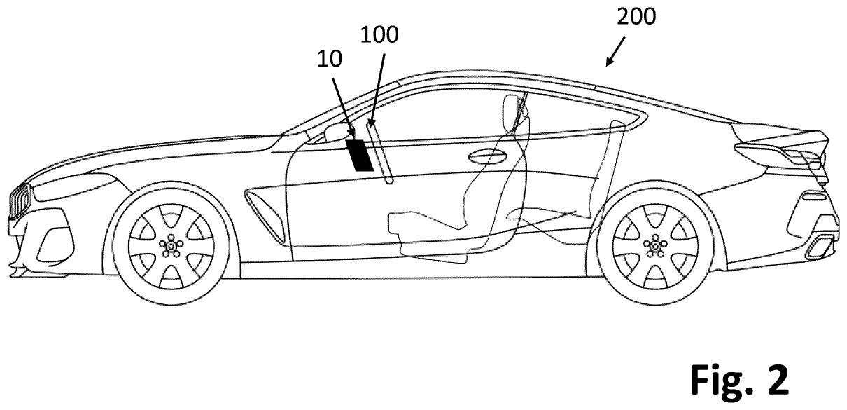

FIG. 2 shows a schematic illustration of a motor vehicle 200 according to an optional embodiment having a steering wheel 100, wherein the steering wheel 100 has an operating unit 10 according to the optional embodiment shown in FIG. 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 Operating unit
12 Relief-like housing
14 Central plateau
16 Upper bevel
18 Lower bevel
20 First functional group
22 Operating element of the first functional group
30 Second functional group
32 Operating element of the second functional group
34 Cursor button
36 Touch operating element
38 Depression
40 Third functional group
42 Operating element of the third functional group
100 Steering wheel
200 Motor vehicle

What is claimed is:

1. An operating unit for arrangement on a steering wheel in a motor vehicle, the operating unit comprising:
a plurality of operating elements of a first functional group;
a plurality of operating elements of a second functional group;
a relief-shaped main body having a central plateau, an upper bevel and a lower bevel, wherein
the operating elements of the first functional group are arranged in the central plateau, and
the operating elements of the second functional group are arranged in the upper bevel and the lower bevel.

2. The operating unit according to claim 1, wherein
the upper bevel and the lower bevel are chamfered with respect to the central plateau.

3. The operating unit according to claim 1, wherein the operating elements of the second functional group comprise one or more of:
operating elements for controlling a playback volume; or
operating elements for gradually changing a playback title.

4. The operating unit according to claim 1, wherein the operating elements of the first functional group comprise one or more of:
operating elements for list navigation and/or menu control;
operating elements for selecting a source for a playback of media contents; or
operating elements for controlling a telephone function.

5. The operating unit according to claim 4, wherein the operating elements for the list navigation and/or the menu control comprise a plurality of cursor buttons, wherein:
one cursor button of the plurality of cursor buttons is arranged on an upper edge of the central plateau,
one cursor button is arranged on a lower edge of the central plateau,
one cursor button is arranged on a left-hand edge of the central plateau, and
one cursor button is arranged on a right-hand edge of the central plateau.

6. The operating unit according to claim 5, wherein the plurality of cursor buttons are raised in a relief manner with respect to the central plateau.

7. The operating unit according to claim 5, further comprising:
a touch operating element which is arranged in a relief depression in the central plateau, wherein the depression is arranged, with the touch operating element, between the cursor buttons.

8. The operating unit according to claim 6, wherein the cursor buttons are chamfered in a manner tapering to the depression.

9. A steering wheel for a motor vehicle comprising an operating unit according to claim 1.

10. A motor vehicle comprising an operating unit according to claim 1.
